(19) United States
(12) Patent Application Publication
(10) Pub. No.: US 2015/0151363 A1
(43) Pub. Date: Jun. 4, 2015

(54) SURFACE MACHINING APPARATUS

(71) Applicants: Anthony Edward Backhouse, Williamstown, Melbourne, Victoria (AU); Douglas Schafer, Point Cook, Melbourne, Victoria (AU)

(72) Inventors: Anthony Edward Backhouse, Williamstown, Melbourne, Victoria (AU); Douglas Schafer, Point Cook, Melbourne, Victoria (AU)

(73) Assignee: FURMANITE AUSTRALIA PTY. LTD., Port Melbourne, VICTORIA (AU)

(21) Appl. No.: 14/117,561

(22) PCT Filed: May 10, 2012
(86) PCT No.: PCT/AU12/00505

§ 371 Date: Feb. 5, 2015

(30) Foreign Application Priority Data
May 13, 2011 (AU) 2011901838

(51) Int. Cl. B23B 3/26; B23Q 5/28

(52) U.S. Cl. CPC B23B 3/265; B23Q 5/28

(57) ABSTRACT

A facing arm for machining a surface of a workpiece, including: a machining element which is movable along an axis of the facing arm thereby to position the machining element relative to the surface of the workpiece; and electrically powered drive means for moving the machining element along the axis of the facing arm.

### TECHNICAL FIELD

The present invention relates to an apparatus and a system for machining surfaces, and is particularly, though not exclusively, useful in surfacing flanges of pipes, vessels, reactors, valves and the like as well as faces associated with portable boring bar activities.

### BACKGROUND

Degradation of the flange surface on industrial flanges and vessel/reactor gasket surfaces can lead to leakage and so these flange surfaces or gasket faces can require resurfacing from time to time.

Portable flange facers have been developed in order to resurface flanges without having to remove and transport entire pipe sections or vessels. A portable flange facer generally consists of a boom or arm, known as a facing arm, mounted to a spindle of a support structure. The support structure is securable to the internal diameter of the flange or the vessel. The facing arm is rotatable about the spindle and includes a cutting tool for machining the flange surface.

A known problem with existing portable flange facing machines is that axial movement of the tool post carrying the cutting tool towards or away from the spindle is achieved by mechanical means, for example by a control crank, as described in U.S. Pat. No. 5,630,346. The gear boxes of known flange facers are limited to three or four gears, and additional gears must be employed in order to reverse the tool post.

An additional problem with known machines is that, in order to move the cutting tool to set spigot positions or ‘V’ grooves, the operator must watch the cutting tool carefully and stop the machine at the correct instant. If the operator is distracted, the cutting tool can dig into the spigot face, potentially causing damage to the spigot and to the machine.

A further problem with manual operation of known machines as described above is that the operator is required to be in close contact with the machine, posing a safety hazard to the operator.

A similar problem exists during boring operations using portable boring bars which are used for both refurbishment and new construction. A mechanically driven facing arm (typically positioned at right angles to the axial line of the bore) and used to machine faces has the same mechanical complexity as described above, is typically limited to one feed rate per revolution of the bar and again there is difficulty in providing precise control regarding spigot face diameters and the like.

It would be desirable to provide apparatus that overcomes or alleviates one or more of the above problems, or at least provides a useful alternative.

### SUMMARY OF THE INVENTION

According to one aspect of the present invention, there is provided a facing arm for machining a surface of a workpiece, including:
a machining element which is movable along an axis of the facing arm thereby to position the machining element relative to the surface of the workpiece; and
electrically powered drive means for moving the machining element along the axis of the facing arm.

By this powered means for the feeding of the machining element there is provided a much larger range of control than is possible for a mechanically driven machining element. Continuous motion (infinitely variable feed) of the machining element is possible, allowing for a large range of surface finishes, and a cutting tool of the machining element can be stopped at very precise locations. Furthermore, the direction of motion of the machining element along the axis may easily be reversed.

A battery can be used to power the drive means. Alternatively, a slip ring system or any other suitable power source can be used to provide electrical power to the drive means.

In some embodiments the powered drive means is housed within an arm casing. This provides for a compact arrangement which is easily assembled. It is also possible to mount the drive outside the body of the arm, which might be desirable for small arm assemblies which have space limitations.

In a presently preferred embodiment, the facing arm further includes a computerised control module for the powered drive means, such as a CNC module. Computer control of the drive means allows a desired sequence of precise cutting operations for the cutting tool to be programmed, for example.

The computerised control module may be operably couplable to a remote control module for wirelessly receiving instructions to operate the drive means. This may be in the form of a hand held wireless device such as a mobile computing device with wireless communication capabilities, for example.

The use of a remote control enables the operator to stop and start the machining element and hence the cutting action at will. The feed rate may be infinitely varied between zero and maximum feed rate. In general, the maximum feed rate would be used only for returning the tool, not for carrying out a machining operation. In addition it would be possible to stop the machining element at any desired preset position, either on the internal diameter or the external diameter of the cut.

A particular advantage of wireless operation of the controller is that the operator can be located remotely of the apparatus, perhaps tens or even hundreds of metres depending on the range of the wireless receiver of the control module. A flange facing machine having a rotating arm can be hazardous to the operator and it is much preferred that the operator not be standing in close proximity while the machine is operational.

A further advantage of wireless operation is that the operator may reprogram the controller on the fly, rather than connecting and disconnecting a computer in order to issue different sets of instructions to the controller.

In certain embodiments, the computerised control module is located within an internal cavity of the arm casing.

The drive means may include a lead screw, preferably coupled to a servo motor.

In a second aspect, the present invention provides an apparatus for machining a surface of a workpiece, the apparatus including a support structure and a facing arm according to the first aspect of the invention, the facing arm being mounted to the support structure for motion relative to the support structure.

The apparatus may further include a second electrically powered drive means for moving the facing arm along the axis of the spindle. In certain embodiments, the apparatus further includes a second computerised control module for the second electrically powered drive means, wherein the second computerised control module is operably couplable to the remote control module.

In a third aspect, the present invention provides a system for machining a surface of a workpiece, including a support structure, a facing arm mountable to the support structure for motion relative to the support structure, and a remote control module, wherein the facing arm includes: a machining element which is movable along an axis of the facing arm thereby to position the machining element relative to the surface of the workpiece, and electrically powered drive means for moving the machining element along the axis of the facing arm; and wherein the facing arm is operably couplable to the remote control module for wirelessly receiving instructions to operate the drive means.

### BRIEF DESCRIPTION OF THE DRAWINGS

Embodiments of the invention will now be described, by way of non-limiting example only, with reference to the accompanying drawings, in which:

FIG. 1 is a plan view from above of an exemplary facing arm;

FIG. 2 shows the facing arm of FIG. 1 in use as part of a flange facing apparatus;

FIG. 3 is a plan view from one side of the flange facing apparatus of FIG. 2;

FIG. 4 is a sectional view of FIG. 2; and

FIG. 5 shows a facing arm in use with a portable boring bar.

### DETAILED DESCRIPTION

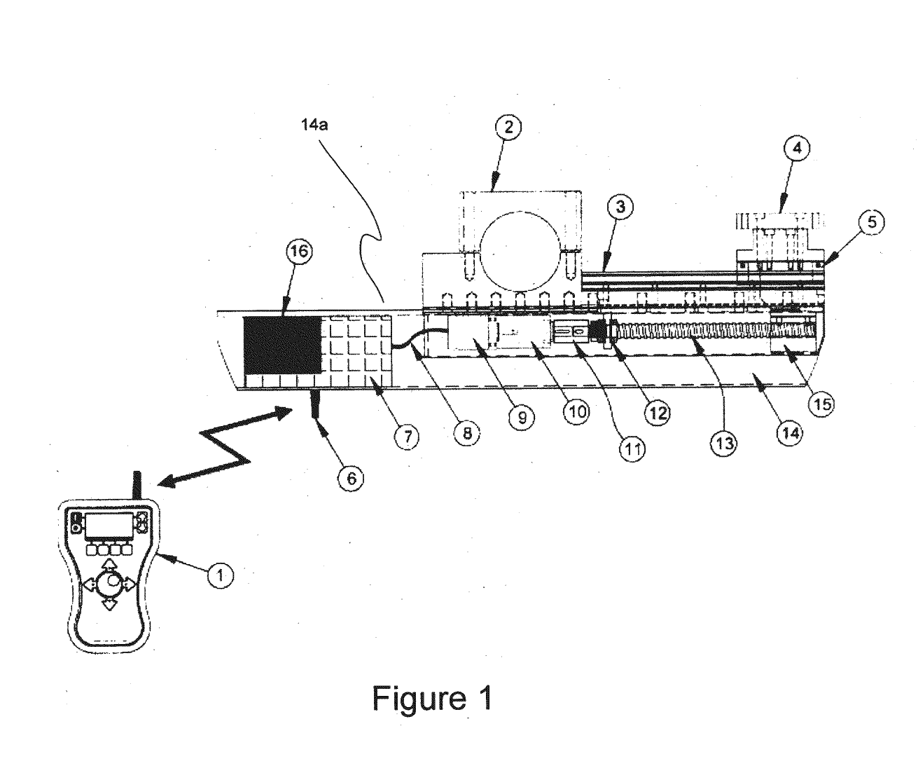

Referring initially to FIG. 1, there is shown a facing arm 14, including an arm casing 14a having an internal cavity which houses electrically powered drive means including feed motor 9, feed gearbox 10, drive coupling 11, thrust bearings 12 and lead screw 13. A battery 16 provides power to a control module 7, and to the feed motor 9.

The facing arm 14 includes a machining element in the form of a tool post 4 for receiving a cutting tool. The tool post 4 is mounted to a runner block 5 which is adapted to move along a linear rail 3 so as to position the tool post 4. The tool post 4 may alternatively move along a “Vee” bed (not shown).

Control module 7 is in communication with a wireless remote control module 1 via an RF antenna 6 mounted to the arm casing 14a. The wireless remote control module 1 may be a custom controller with circuitry for implementing a predetermined set of functions. In other embodiments, the controller 1 may include user-programmable circuitry. In yet further embodiments, the controller may include circuitry for implementing a combination of pre-configured and user-programmable functions.

As a yet further alternative, the wireless remote control module 1 may be a general purpose device enabled for wireless communication, such as a mobile phone, handheld computing device or commercially available desktop or laptop computer system based on a 32-bit or 64-bit Intel architecture. Exemplary mobile computing devices usable with embodiments of the invention include iPad® and iPhone® of Apple Inc.

The remote control module 1 includes a plurality of standard software modules, including an operating system (OS) such as iOS or Android in the case of a mobile computing device, or Linux or Microsoft Windows in the case of a desktop or laptop computer system.

Instructions for generating signals to be received by the antenna 6 for operation of facing arm 14 may be implemented in the form of programming instructions of one or more software components or modules stored on non-volatile (e.g., hard disk) computer-readable storage associated with the remote control module 1. The instructions may include instructions for controlling the axis functions and/or for full Computer Numerical Control (CNC) of the boring bar by programming sequences of movement along the axial and the radial axis.

The signals transmitted by wireless controller 1 are received at antenna 6 and then translated by a suitable adapter, for example a WiFi to serial adapter, forming part of the control module 7. The control module 7 then drives feed motor 9, and thus tool post 4, according to the signals received from the wireless controller 1.

Although the control module 7 is shown connected to the feed motor 9 via a cable 8, it will also be appreciated that the control module 7 and feed motor 9 may form a single assembly, i.e. the control module 7 may be built into the feed motor 9.

A representative set of possible instructions transmissible by wireless remote control 1 to control module 7 may include:
homing the tool post 4;
jogging the tool post 4 along the rail 3 (in response to a keypress, dial or toggle);
moving the tool post 4 to a set position along the rail 3;
setting the feed rate of the lead screw 13.

Pre-programmed combinations of the above instructions are of course also possible.

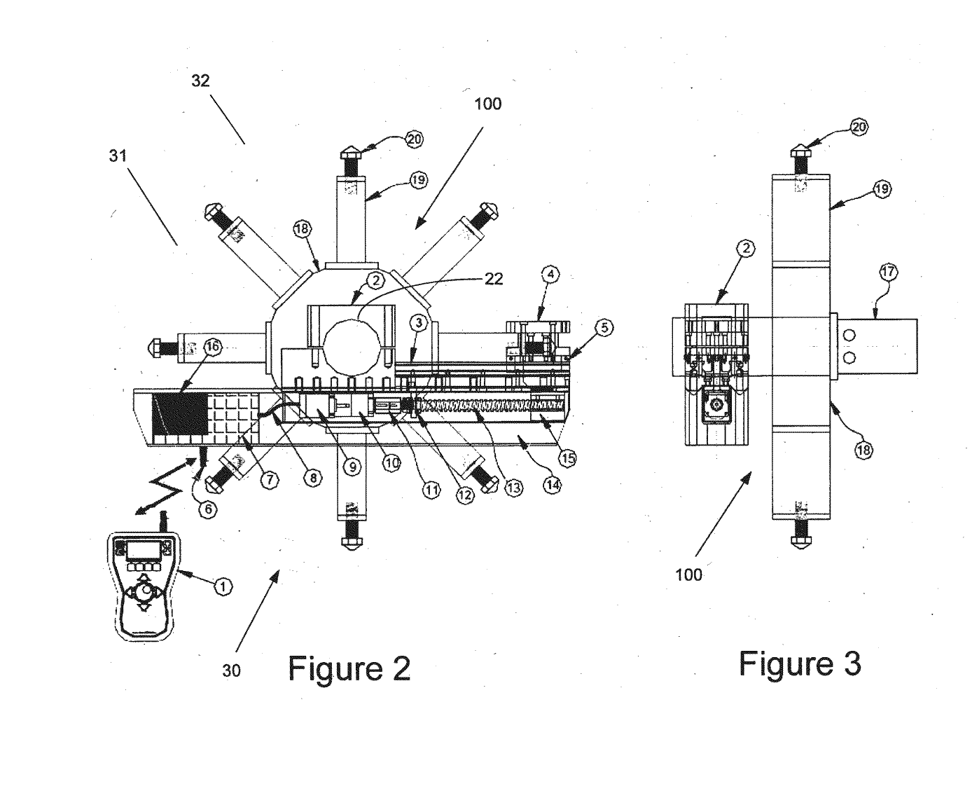

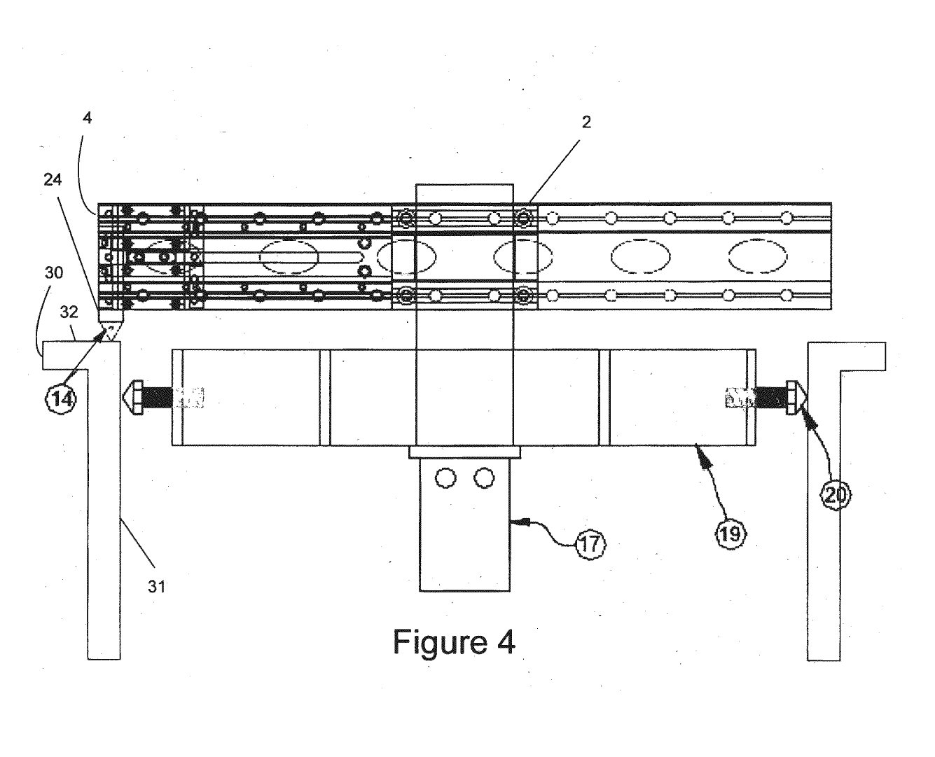

Turning now to FIGS. 2 and 4, the facing arm 14 is shown schematically in use as part of a flange facing machine 100. The flange facing machine 100 is shown attached to a substantially circular workpiece in the form of a pipe having a flange 30 with an exposed outer surface 32 which is to be machined.

The flange facing machine 100 includes a support structure (‘spider’) 18 with a plurality of legs 19 extending therefrom. Each leg 19 has a screw-threaded locking bolt 20 at its extremity to engage with an internal surface 31 of the pipe so that the support structure 18 is held fixed relative to the pipe. The locking bolts 20 are adjustable to locate the spindle 22 of the support structure 18 at the centre of the pipe.

The facing arm 14 is fixed to the spindle 22 of the support 18 by a hub clamp 2. In operation, a cutting tool 24 held by tool post 4 is brought into engagement with the surface 32 and the facing arm 14 is then rotated by virtue of rotational motion of the spindle 22 in order to machine the surface 32. Spindle 22 may be actuated by any suitable means, for example by a hydraulic motor 17 as shown in FIGS. 3 and 4.

In order to adjust the position of the tool holder 4 and cutting tool held therein, an operator issues instructions via a user interface of wireless controller 1, which are then received by antenna 6 and communicated to control module 7. Standard communication protocols as known in the art, such as those compliant with the IEEE 802.11 or IEEE 802.15 set of standards, may be used to establish the connection between the remote control 1 and the control module 7.

The use of a wireless controller 1 permits the operator to remotely adjust the position of the tool post 4 relative to the spindle 22 and thus greatly reduces the risk of injury to the operator during operation of the flange facing apparatus 100.

Once instructions to move the tool post 4 are received by the control module 7, the feed motor 9, which may be a servo motor or a stepper motor, drives the lead screw 13 in order to move the tool post 4 along the axis of the facing arm 14, i.e. towards or away from the spindle 22. The thread of the lead screw 13 traverses the ball nut 15 located at the base of the tool post 4 in order to drive the tool post 4.

The feed motor 9 may drive the lead screw 13 directly, or may drive it via an optional gear box 10. A planetary gear box is particularly preferred because it provides for a lighter and more convenient arrangement than known drive mechanisms for flange facing machines and boring bars.

A rotary positioner or a linear scale may be used to give feedback to the control module 7 regarding the position of the tool post 4. If a stepper motor is used as feed motor 9, the position of the tool post 4 may be monitored by counting the number of pulses received by the stepper motor.

A replaceable battery system can be used to power the drive means. A charger may advantageously be provided to ensure that a replacement charged battery is always available. Alternatively, a slip ring system can be used to provide electrical power to the rotating housing on which the facing arm is mounted.

The electrically powered drive means of the facing arm 14 permits the operator of the flange facing machine to exercise a fine degree of control over the position of the cutting tool. Accordingly, a wide variety of different depths and shapes of cut are possible. Once the facing arm 14 is in the desired position relative to the surface 32 to be machined, a cut is established on the surface 32 either by a partial rotation of the facing arm 14 about the spindle 22, or by driving the tool post 4 along the axis of the facing arm 14 in order to traverse the surface 32 with a linear trajectory.

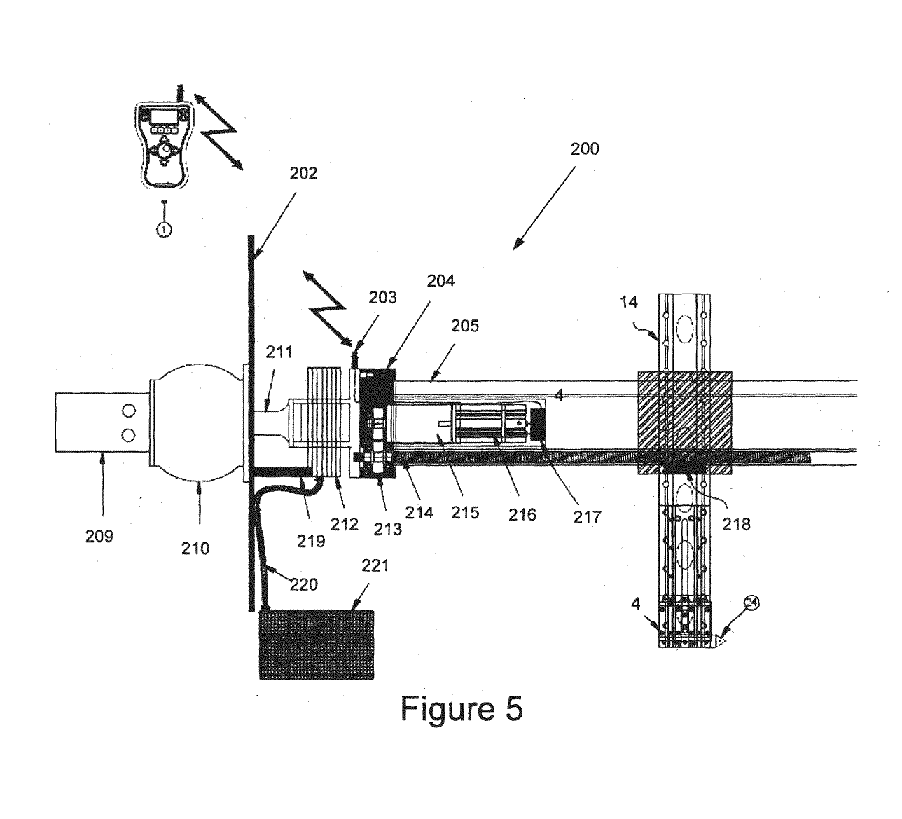

Turning now to FIG. 5, there is shown an alternative application of the facing arm 14, in which the facing arm 14 is attached to a boring bar 200 via a saddle 208. The boring bar 200 includes a hydraulic drive motor 209 coupled to a drive gearbox 210 which reacts off torque reaction arm 202 to provide rotational drive to the bar 200, via spline adaptor 211. In this embodiment, the boring bar 200 forms a support structure for the facing arm 14.

The boring bar 200 is powered by slip rings 212 which are in electrical communication with a low voltage power supply 221 via cable 220. The slip rings 212 react off the reaction arm 202 via slip ring reaction arm 219.

The boring bar 200 includes, in addition to the first electrically powered drive means used to drive the tool post 4 along the axis of the facing arm 14, a second electrically powered drive means for moving the facing arm 14 along the axis of the spindle of boring bar 200. The second electrically powered drive means comprises gears 213 housed in 1:1 gearbox housing 204, feed gearbox 215, and feed servo motor 216. The feed servo motor 216 is in communication with a second computerised control module 217 which in turn communicates wirelessly with remote control 1 via RF antenna 203.

When the facing arm 14 is associated with a boring bar 200 as shown in FIG. 5, the wireless hand held controller 1 can control both the movement of the saddle 208 carrying the facing arm 14 along the axis of the boring bar 200, as well as the operation of the facing arm 14 as described above in relation to flange facing machines.

For example, an operator can issue a command from remote control 1 to second control module 217 to cause the feed servo motor 216 to drive the boring bar lead screw 214 along lead nut 218, which in turn translates the saddle 208 along the axis of the spindle to a desired position. The operator can then issue a further command from remote control 1 to the first control module 7 to move the tool post 4 to a desired position in order to machine a surface using the cutting tool 24.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A facing arm for machining a surface of a workpiece, including:
a machining element which is movable along an axis of the facing arm thereby to position the machining element relative to the surface of the workpiece; and
electrically powered drive means for moving the machining element along the axis of the facing arm.

2. A facing arm according to claim 1, including an arm casing for housing the electrically powered drive means.

3. A facing arm according to claim 2, further including a computerised control module coupled to the electrically powered drive means.

4. A facing arm according to claim 3, wherein the computerised control module is a CNC module.

5. A facing arm according to claim 1, wherein the facing arm is operably couplable to a remote control module for wirelessly receiving instructions to operate the drive means.

6. A facing arm according to claim 5, wherein the computerised control module is operably couplable to the remote control module.

7. A facing arm according to claim 3, wherein the computerised control module is located within an internal cavity of the arm casing.

8. A facing arm according to claim 1, wherein the drive means includes a lead screw.

9. A facing arm according to claim 1, wherein the drive means includes a servo motor or a stepper motor.

10. A facing arm according to claim 1, further including a clamp for mounting the arm to a support structure.

11. Apparatus for machining a surface of a workpiece, including a support structure, and a facing arm according to claim 1, the facing arm being mounted to the support structure for motion relative to the support structure.

12. Apparatus according to claim 11, wherein the facing arm is mounted to a spindle of the support structure for rotational motion about the spindle.

13. Apparatus according to claim 12, further including a second electrically powered drive means for moving the facing arm along the axis of the spindle.

14. Apparatus according to claim 13 when appended to any one of claims 4 to 9, further including a second computerised control module for the second electrically powered drive means, wherein the second computerised control module is operably coupled to the remote control.

15. A system for machining a surface of a workpiece, including a support structure, a facing arm mountable to the support structure for motion relative to the support structure, and a remote control module, wherein the facing arm includes: a machining element which is movable along an axis of the facing arm thereby to position the machining element relative to the surface of the workpiece, and electrically powered drive means for moving the machining element along the axis of the facing arm; and wherein the facing arm is operably couplable to the remote control module for wirelessly receiving instructions to operate the drive means.

16. A facing arm according to claim 1, further including a computerised control module coupled to the electrically powered drive means.

17. A facing arm according to claim 4, wherein the computerised control module is located within an internal cavity of the arm casing.

18. A facing arm according to claim 2, wherein the facing arm is operably couplable to a remote control module for wirelessly receiving instructions to operate the drive means.

19. A facing arm according to claim 3, wherein the facing arm is operably couplable to a remote control module for wirelessly receiving instructions to operate the drive means.

20. A facing arm according to claim 4, wherein the facing arm is operably couplable to a remote control module for wirelessly receiving instructions to operate the drive means.
